(19) United States
(12) Patent Application Publication
(10) Pub. No.: US 2014/0223294 A1
(43) Pub. Date: Aug. 7, 2014

(54) DOCUMENT EDITING APPARATUS, DOCUMENT EDITING METHOD, AND NON-TRANSITORY COMPUTER READABLE MEDIUM

(71) Applicant: FUJI XEROX CO., LTD., Tokyo (JP)

(72) Inventors: Daisuke TATSUMI, Kanagawa (JP); Takeshi ONISHI, Kanagawa (JP); Hiroyuki SAYUDA, Kanagawa (JP); Eisaku HAYASHI, Kanagawa (JP)

(73) Assignee: FUJI XEROX CO., LTD., Tokyo (JP)

(21) Appl. No.: 13/967,855

(22) Filed: Aug. 15, 2013

(30) Foreign Application Priority Data
Feb. 4, 2013 (JP) 2013-019329

(51) Int. Cl. G06F 17/24

(52) U.S. Cl. CPC G06F 17/24
USPC 715/255

(57) ABSTRACT

A document editing apparatus includes a link information extracting unit and a changing unit. The link information extracting unit extracts link information linked to other data from a target document. The changing unit changes the link information to information that is not linked to the other data if the other data to which the extracted link information is linked includes concealed information.

### CROSS-REFERENCE TO RELATED APPLICATIONS

This application is based on and claims priority under 35 USC 119 from Japanese Patent Application No. 2013-019329 filed Feb. 4, 2013.

### BACKGROUND

1. Technical Field

The present invention relates to a document editing apparatus, a document editing method, and a non-transitory computer readable medium.

2. Summary

According to an aspect of the invention, there is provided a document editing apparatus including a link information extracting unit and a changing unit. The link information extracting unit extracts link information linked to other data from a target document. The changing unit changes the link information to information that is not linked to the other data if the other data to which the extracted link information is linked includes concealed information.

### BRIEF DESCRIPTION OF THE DRAWINGS

Exemplary embodiments of the present invention will be described in detail based on the following figures, wherein:

FIG. 1 is an exemplary functional block diagram of a document editing apparatus according to an exemplary embodiment;

FIG. 2 illustrates an exemplary concealed information management table;

FIG. 3 illustrates an exemplary replacement information management table;

FIG. 4 is a flowchart illustrating an exemplary editing process performed by the document editing apparatus;

FIG. 5 is a flowchart illustrating the exemplary editing process performed by the document editing apparatus;

FIG. 6 is a flowchart illustrating the exemplary editing process performed by the document editing apparatus;

FIG. 7 illustrates an exemplary target document;

FIG. 8 illustrates an example of how the target document is edited;

FIG. 9 illustrates another example of how the target document is edited;

FIG. 10 illustrates another example of how the target document is edited;

FIG. 11 illustrates another example of how the target document is edited; and

FIG. 12 illustrates another example of how the target document is edited.

### DETAILED DESCRIPTION

Exemplary embodiments of the present invention will herein be described with reference to the attached drawings.

### [1. Description of Functions of Document Editing Apparatus]

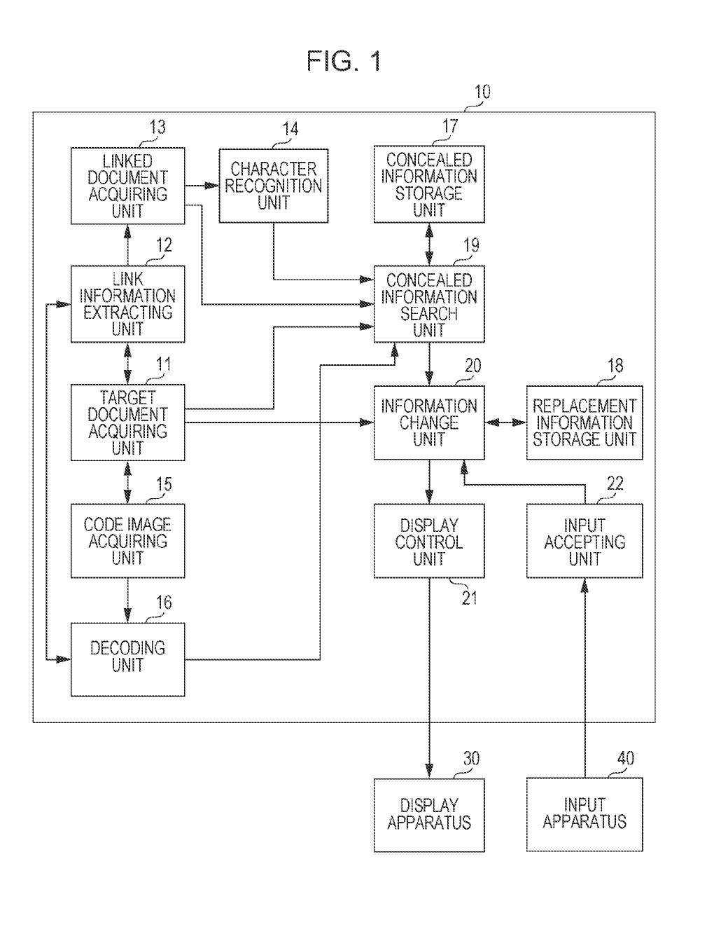

FIG. 1 is an exemplary functional block diagram of a document editing apparatus 10 according to an exemplary embodiment. Referring to FIG. 1, the document editing apparatus 10 includes a target document acquiring unit 11, a link information extracting unit 12, a linked document acquiring unit 13, a character recognition unit 14, a code image acquiring unit 15, a decoding unit 16, a concealed information storage unit 17, a replacement information storage unit 18, a concealed information search unit 19, an information change unit 20, a display control unit 21, and an input accepting unit 22.

The functions of the above components in the document editing apparatus 10 may be realized by a computer that includes a control unit such as a central processing unit (CPU), a storage unit such as a memory, an input-output unit transmitting and receiving data to and from an external device, and so on and that reads out and executes a program stored in a computer-readable information storage medium. The program may be supplied to the document editing apparatus 10, which is the computer, via an information storage medium, such as an optical disk, a magnetic disk, a magnetic tape, a magneto-optical disk, or a flash memory. Alternatively, the program may be supplied to the document editing apparatus 10 via a data communication network, such as the Internet.

The target document acquiring unit 11 acquires a document to be edited (a target document). For example, the target document acquiring unit 11 may acquire an electronic document instructed by a user, among the electronic documents stored in a memory, a hard disk, an information storage medium, etc., as the target document or may acquire an electronic document downloaded via a network in response to an instruction from the user as the target document.

The link information extracting unit 12 extracts link information from the target document acquired by the target document acquiring unit 11. For example, the link information extracting unit 12 may extract a character string for which a hyperlink is set and a character string described in a hyperlink format as the link information. Alternatively, the link information extracting unit 12 may extract the link information also from data decoded by the decoding unit 16 described below.

The linked document acquiring unit 13 accesses the link information extracted by the link information extracting unit 12 to acquire a document which the link information refers to (a linked document). The linked document acquiring unit 13 may supply the linked document to the concealed information search unit 19 when the linked document is an electronic document (information including character string data) and may supply the linked document to the character recognition unit 14 when the linked document is a document image (image data).

The character recognition unit 14 performs character recognition processing to a document image when the linked document acquired by the linked document acquiring unit 13 is the document image to convert the document image into an electronic document. The character recognition unit 14 supplies the electronic document converted from the document image on the basis of the character recognition processing to the concealed information search unit 19.

The code image acquiring unit 15 extracts a code image from the target document acquired by the target document acquiring unit 11. The code image may be, for example, a one-dimensional code (a bar code) or a two-dimensional code (a Quick Response (QR) code (registered trademark).

The decoding unit 16 decodes data encoded in the code image acquired by the code image acquiring unit 15. The data decoded by the decoding unit 16 (decoded data) is supplied to the concealed information search unit 19.

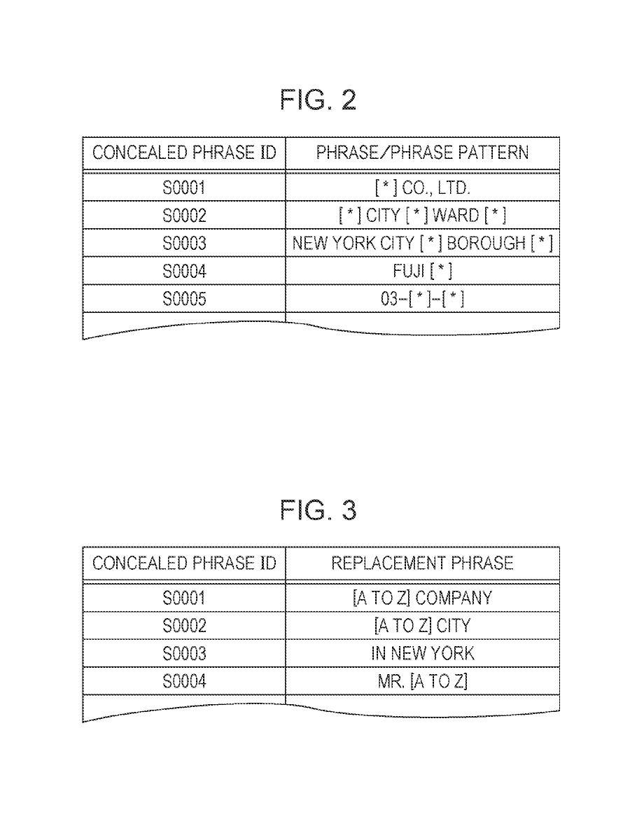

The concealed information storage unit 17 stores information for identifying concealed information (phrase) including a personal name, a company name, an address, and a telephone number. For example, an exemplary concealed information management table illustrated in FIG. 2 is stored in the concealed information storage unit 17. Concealed phrase identifiers (IDs) for identifying concealed phrases and phrase-phrase patterns are stored in the exemplary concealed information management table illustrated in FIG. 2 in association with each other. In the phrase-phrase patterns illustrated in FIG. 2, [*] denotes an arbitrary character string.

The replacement information storage unit 18 stores information about replacement phrases used when the concealed information is replaced with other open information. For example, an exemplary replacement information management table illustrated in FIG. 3 is stored in the replacement information storage unit 18. The concealed phrase IDs and the replacement phrases with which the phrase-phrase patterns associated with the concealed phrase IDs are replaced are stored in the exemplary replacement information management table illustrated in FIG. 3 in association with each other. In the replacement phrases illustrated in FIG. 3, [A to Z] indicates that one character in the characters [A to Z] is allocated in order to allow each proper name in the same document to be identified.

The concealed information search unit 19 searches each of the target document acquired by the target document acquiring unit 11, the linked document acquired by the linked document acquiring unit 13, the linked document converted into the electronic document by the character recognition unit 14, and the decoded data decoded by the decoding unit 16 for the concealed information (the phrase-phrase pattern) stored in the concealed information storage unit 17.

The information change unit 20 masks (fills) the concealed information searched for by the concealed information search unit 19 or replaces the concealed information with other open information to change the content of the target document. For example, the information change unit 20 may display a confirmation screen of the concealed information searched for by the concealed information search unit 19 in a display apparatus 30 via the display control unit 21 and, upon acceptance of a concealment instruction input by the user with an input apparatus 40 via the input accepting unit 22, may perform an information changing process to mask the concealed information or replace the concealed information with other information. The process of changing the concealed information will be described in detail below.

The display control unit 21 is connected to the display apparatus 30, such as a liquid crystal display, to transmit display information to the display apparatus 30.

The input accepting unit 22 is connected to the input apparatus 40 including a mouse, a keyboard, and so on to accept information input by the user with the input apparatus 40.

### [2. Description of Editing Process Performed by Document Editing Apparatus 10]

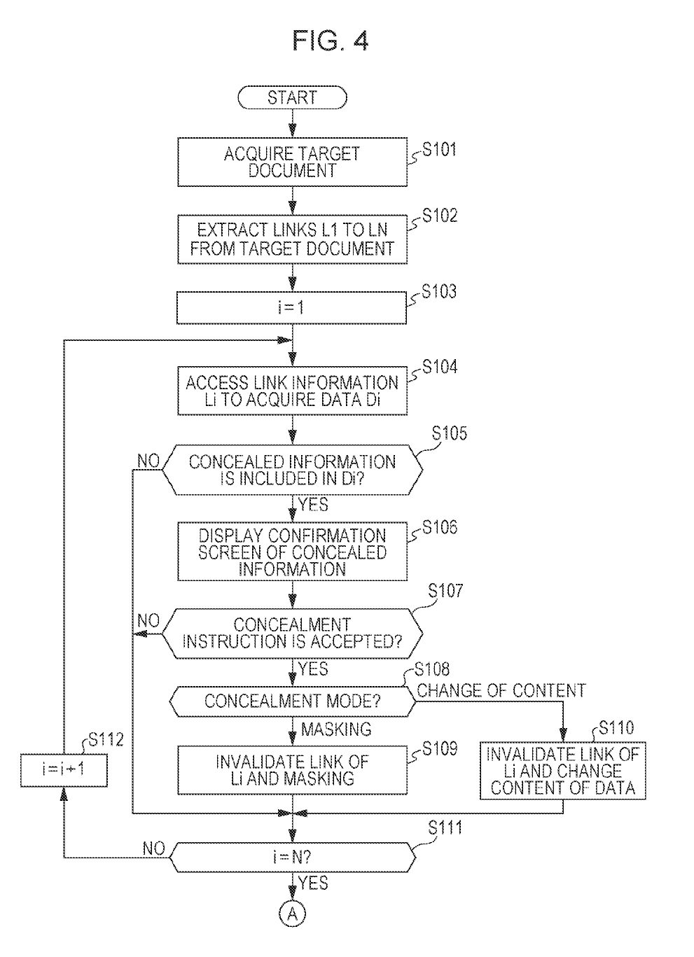

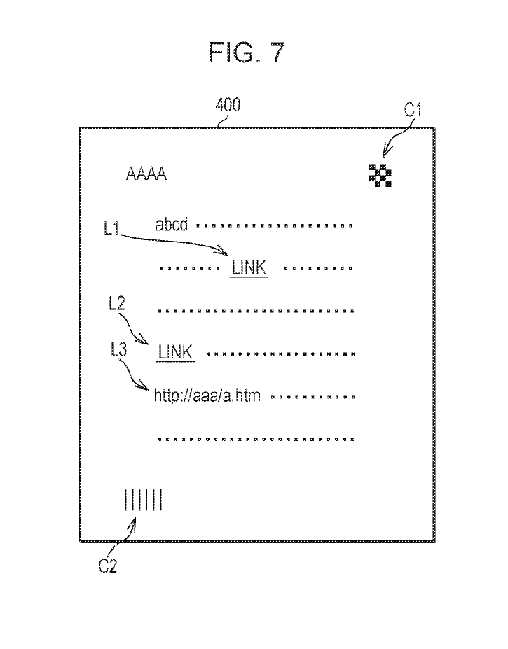

An editing process performed by the document editing apparatus 10 will now be described in detail with reference to flowcharts in FIGS. 4 to 6. FIGS. 7 to 12 illustrate exemplary editing screens of the target document in response to the editing process performed by the document editing apparatus 10.

### [2-1. Processing for Link Information Included in Target Document]

Referring to FIG. 4, in Step S101, the document editing apparatus 10 acquires the target document to be edited in response to, for example, an instruction accepted from the user.

FIG. 7 illustrates an example of a document display screen in which the target document is displayed. A target document 400 displayed in the document display screen includes links L1 to L3 and code images C1 and C2 in the example illustrated in FIG. 7.

In Step S102, the document editing apparatus 10 extracts all the pieces of link information (links L1 to LN) included in the target document from the target document. In Step S103, the document editing apparatus 10 initializes a variable i to one (i=1). In Step S104, the document editing apparatus 10 accesses link information Li to acquire data Di which the link information Li refers to. When the data Di is not an electronic document but an image, the document editing apparatus 10 may perform the character recognition processing to the data Di to convert the image into the electronic document.

In Step S105, the document editing apparatus 10 determines whether the concealed information is included in the data Di on the basis of the concealed information management table. If the concealed information is included in the data Di (YES in Step S105), in Step S106, the document editing apparatus 10 displays the confirmation screen for confirming the content of editing of the concealed information.

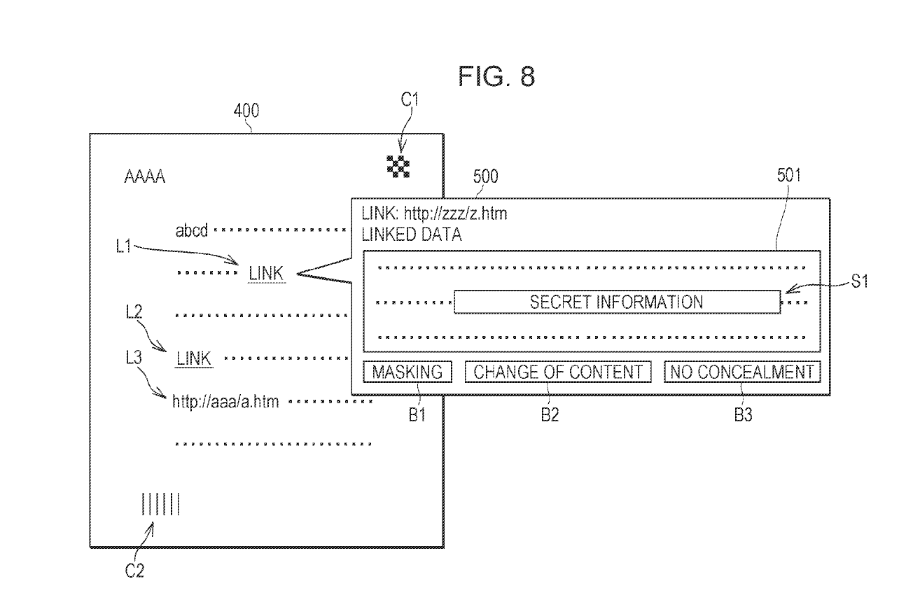

FIG. 8 illustrates an example of the confirmation screen. FIG. 8 illustrates an example of a confirmation screen 500 for the link L1. A linked data display screen 501 on which the address of the link and linked data is displayed, a making button B1 for instructing the masking of the link, a change of content button B2 for instructing the change of the content of the link, and a no concealment button B3 for instructing that the concealment of the link is not necessary are displayed on the confirmation screen 500. Secret information S1 (concealed information) is included in the linked data in the example in FIG. 8.

In Step S107, the document editing apparatus 10 determines whether, for example, the making button B1 or the change of content button B2 on the confirmation screen of the link Li is pressed to accept a concealment instruction from the user. If the concealment instruction is accepted from the user (YES in Step S107), in Step S108, the document editing apparatus 10 determines the concealment mode. If the concealment mode is “masking” (MASKING in Step S108), in Step S109, the document editing apparatus 10 invalidates the link of the link Li and masks (fills) the character string or the image including the link Li.

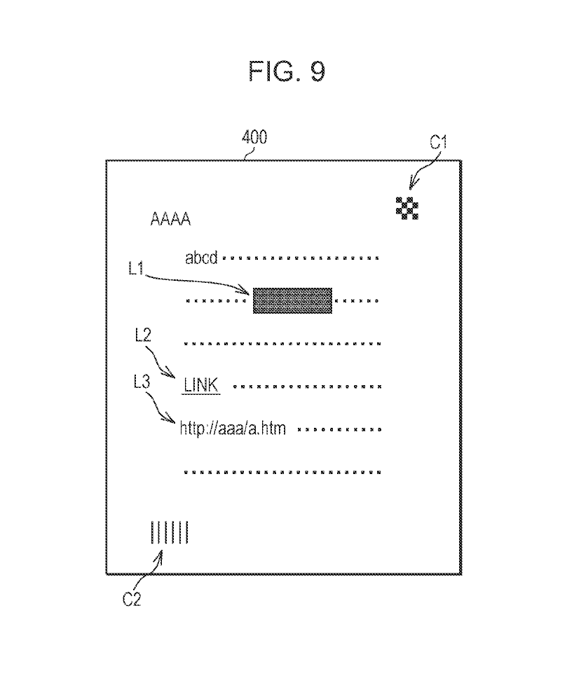

FIG. 9 illustrates an example of editing when the making button B1 is pressed on the confirmation screen of the link L1. The entire character string including the link L1 is masked in the example illustrated in FIG. 9.

If the concealment mode is “change of content” (CHANGE OF CONTENT in Step S108), in Step S110, the document editing apparatus 10 invalidates the link of the link Li and changes the character string or the image including the link Li to another character string or another image that does not include the linked address of the link Li.

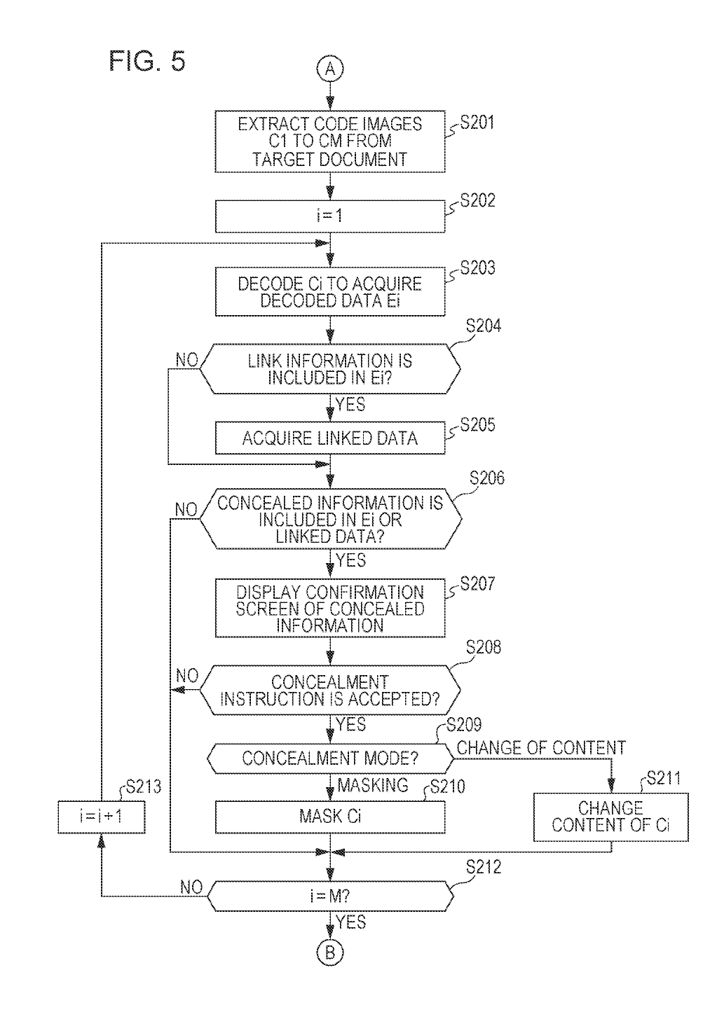

After Step S109 and Step S110, if the document editing apparatus 10 determines that the concealed information is not included in the data Di (NO in Step S105), or if, for example, the no concealment button B3 on the confirmation screen of the link Li is pressed not to accept the concealment instruction from the user (NO in Step S107), the process goes to Step S111. In Step S111, the document editing apparatus 10 determines whether the variable i reaches N. If the variable i does not reach N (NO in Step 5111), in Step S112, the document editing apparatus 10 increments the variable i by one. Then, the process goes back to Step S104. If the variable i reaches N (YES in Step S111), the process goes to the flowchart in FIG. 5.

### [2-2. Processing for Code Image Included in Target Document]

Referring to FIG. 5, in Step S201, the document editing apparatus 10 extracts all the code images (code images C1 to CM) included in the target document from the target document. In Step S202, the document editing apparatus 10 initializes the variable i to one (i=1). In Step S203, the document editing apparatus 10 decodes the code image Ci to acquire decoded data Ei about the code image Ci.

In Step S204, the document editing apparatus 10 determines whether the link information is included in the decoded data Ei. If the link information is included in the decoded data Ei (YES in Step S204), in Step S205, the document editing apparatus 10 accesses the link information to acquire the linked data. If the link information is not included in the decoded data Ei (NO in Step S204) and after Step S205, the process goes to Step S206.

In Step S206, the document editing apparatus 10 determines whether the concealed information is included in the decoded data Ei or the linked data acquired on the basis of the link information included in the decoded data Ei on the basis of the concealed information management table. If the concealed information is included in the decoded data Ei or the linked data acquired on the basis of the link information included in the decoded data Ei (YES in Step S206), in Step S207, the document editing apparatus 10 displays the confirmation screen for confirming the content of editing of the concealed information.

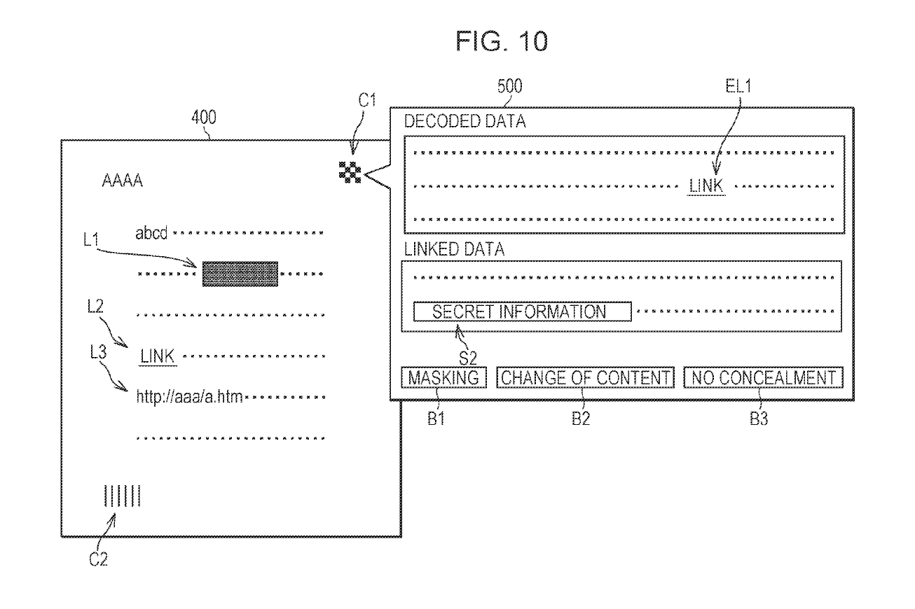

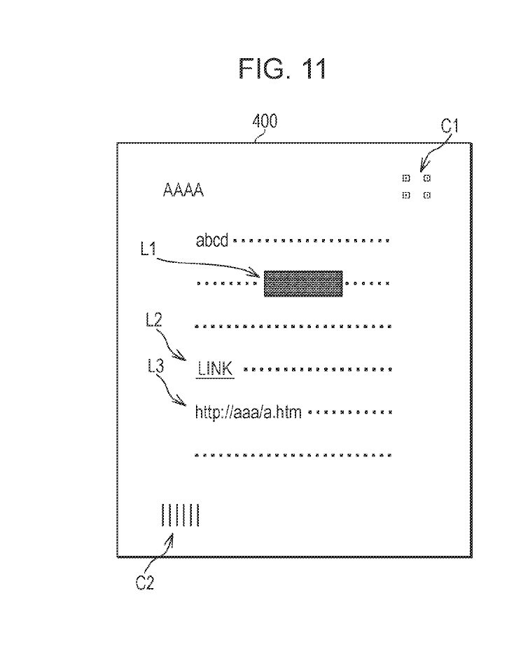

FIG. 10 illustrates an example of the confirmation screen. FIG. 10 illustrates an example of the confirmation screen 500 for the code image C1. A display screen on which decoded data E1 about the code image C1 is displayed, the linked data display screen on which the linked data about a link EL1 included in the decoded data E1 is displayed, the making button B1 for instructing the masking of the code image, the change of content button B2 for instructing the change of the content of the code image, and the no concealment button B3 for instructing that the concealment of the code image is not necessary are displayed on the confirmation screen 500 for the code image C1. Secret information S2 (concealed information) is included in the linked data about the decoded data E1 in the example in FIG. 10.

In Step S208, the document editing apparatus 10 determines whether, for example, the making button B1 or the change of content button B2 on the confirmation screen of the code image Ci is pressed to accept the concealment instruction from the user. If the concealment instruction is accepted from the user (YES in Step S208), in Step S209, the document editing apparatus 10 determines the concealment mode. If the concealment mode is “masking” (“MASKING” in Step S209), in Step S210, the document editing apparatus 10 masks (fills) the code image Ci.

If the concealment mode is “change of content” (“CHANGE OF CONTENT” in Step S209), in Step S211, the document editing apparatus 10 changes the code image Ci to another character string or another image that does not include the decoded data about the code image Ci.

FIG. 11 illustrates an example of editing when the change of content button B2 is pressed on the confirmation screen of the code image C1. The code image C1 is changed to a new code image different from the original code image in the example illustrated in FIG. 11. Data encoded with the new code image is different from the data encoded with the original code image.

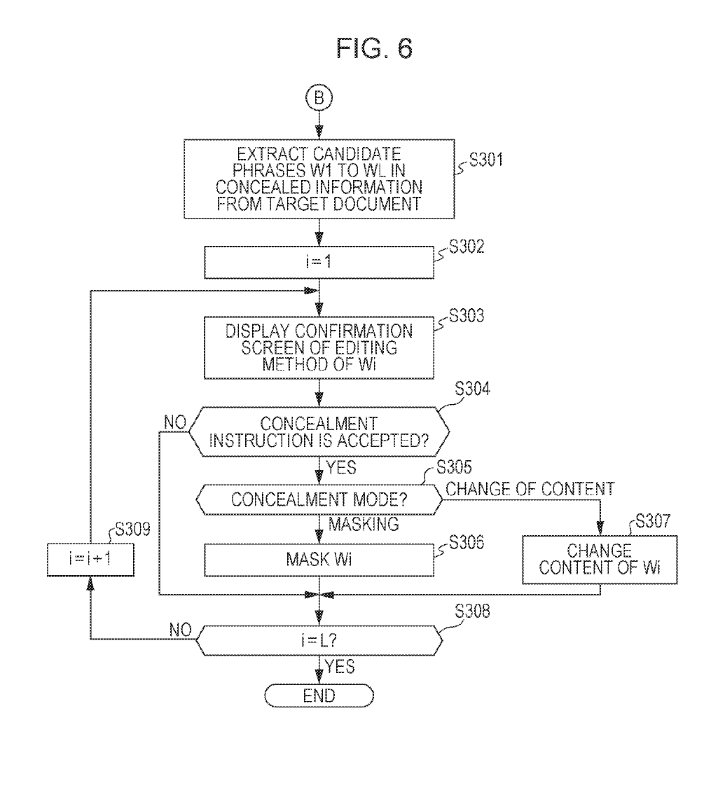

After Step S210 and Step S211, if the document editing apparatus 10 determines that the concealed information is not included in the decoded data Ei or the linked data acquired on the basis of the link information included in the decoded data Ei (NO in Step S206), or if, for example, the no concealment button B3 on the confirmation screen of the code image Ci is pressed not to accept the concealment instruction from the user (NO in Step S208), the process goes to Step S212. In Step S212, the document editing apparatus 10 determines whether the variable i reaches M. If the variable i does not reach M (NO in Step S212), in Step S213, the document editing apparatus 10 increments the variable i by one. Then, the process goes back to Step S203. If the variable i reaches M (YES in Step S212), the process goes to the flowchart in FIG. 6.

### [2-3. Processing for Character String Included in Target Document]

Referring to FIG. 6, in Step S301, the document editing apparatus 10 extracts candidate phrase W1 to WL in all the pieces of concealed information included in the target document on the basis of the concealed information management table. In Step S302, the document editing apparatus 10 initializes the variable i to one (i=1). In Step S303, the document editing apparatus 10 displays the confirmation screen for confirming the method of editing a candidate phrase Wi. The making button B1 for instructing the masking of the candidate phrase, the change of content button B2 for instructing the change of the content of the candidate phrase, and the no concealment button B3 for instructing that the concealment of the candidate phrase is not necessary may be displayed on the confirmation screen.

In Step S304, the document editing apparatus 10 determines whether, for example, the making button B1 or the change of content button B2 on the confirmation screen of the candidate phrase Wi is pressed to accept the concealment instruction from the user. If the concealment instruction is accepted from the user (YES in Step S304), in Step S305, the document editing apparatus 10 determines the concealment mode. If the concealment mode is “masking” (“MASKING” in Step S305), in Step S306, the document editing apparatus 10 masks (fills) the character string including the candidate phrase Wi.

If the concealment mode is “change of content” (“CHANGE OF CONTENT” in Step S305), in Step S307, the document editing apparatus 10 changes the character string including the candidate phrase Wi to another character string that does not include the character string of the candidate phrase Wi. The document editing apparatus 10 may search for the replacement phrase for the candidate phrase Wi on the basis of, for example, the replacement information management table to change the candidate phrase Wi to the replacement phrase that is searched for.

After Step S306 and Step S307 or if, for example, the no concealment button B3 on the confirmation screen of the candidate phrase Wi is pressed not to accept the concealment instruction from the user (NO in Step S304), the process goes to Step S308. In Step S308, the document editing apparatus 10 determines whether the variable i reaches L. If the variable i does not reach L (NO in Step S308), in Step S309, the document editing apparatus 10 increments the variable i by one. Then, the process goes back to Step S303. If the variable i reaches L (YES in Step S308), the process is terminated.

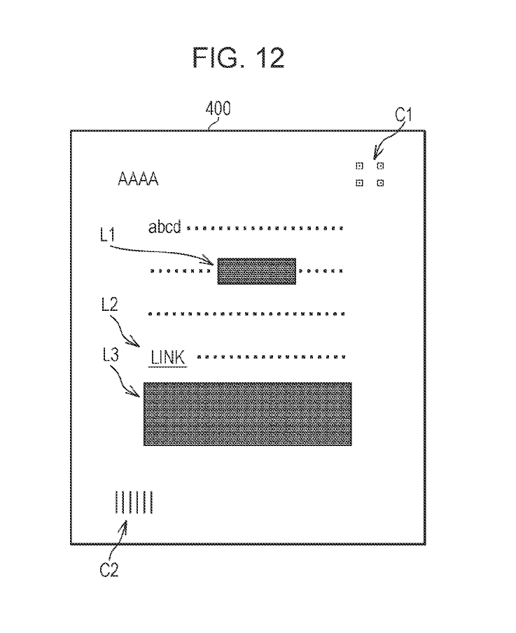

FIG. 12 illustrates an example of how the target document is edited by the document editing apparatus 10. Although the character string including the link L1 is masked, a sentence unit (for example, a line or a paragraph) including the link L3 is masked, and the content of the code image C1 is changed in the example of the editing illustrated in FIG. 12, the content of editing is an example and is not limited to the one illustrated in FIG. 12.

With the document editing apparatus 10 described above, it is possible to edit the target document so that the link including the information to be concealed in its linked data and the code image including the information to be concealed in its encoded data are not opened from the target document.

The present invention is not limited to the exemplary embodiments described above. For example, although the instruction from the user is accepted on the confirmation screen of the concealed information in the above exemplary embodiments, the display of the confirmation screen of the concealed information may be omitted.

Although the example in which the document editing apparatus 10 includes the concealed information storage unit 17 and the replacement information storage unit 18 is described in the above exemplary embodiments, the concealed information storage unit 17 and the replacement information storage unit 18 may be provided in an apparatus outside the document editing apparatus 10 and the document editing apparatus 10 may refer to the concealed information storage unit 17 and the replacement information storage unit 18 provided in the apparatus outside the document editing apparatus 10.

The concealed information search unit 19 may search for a phrase that coincides with or is similar to the concealed phrase stored in the concealed information storage unit 17, among the phrases included in the target document, the linked document of the target document, and the decoded data.

Even if access with the link information about the target document is limited, the document editing apparatus 10 may determine that the link information is the concealed information. Similarly, even if the decoded data resulting from decoding of the code image of the target document is encrypted, the document editing apparatus 10 may determine that the concealed information is included in the code image.

When the concealed information included in the target document is replaced with another character string that is not the concealed information, the document editing apparatus 10 may set a phrase with which the replacement phrase for the concealed information is modified on the basis of a character string described around the concealed information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document editing apparatus comprising:
a link information extracting unit that extracts link information linked to other data from a target document; and
a changing unit that changes the link information to information that is not linked to the other data if the other data to which the extracted link information is linked includes concealed information.

2. The document editing apparatus according to claim 1, further comprising:
a code image extracting unit that extracts a code image from the target document; and
a decoding unit that decodes data encoded in the extracted code image,
wherein, if the data decoded by the decoding unit includes concealed information, the changing unit changes the code image to which the decoded data is encoded to information that does not include the decoded data.

3. The document editing apparatus according to claim 2,
wherein, if the data decoded by the decoding unit includes link information and the other data to which the link information is linked includes concealed information, the changing unit changes the code image to which the decoded data is encoded to information that does not include the link information.

4. The document editing apparatus according to claim 1, further comprising:
a unit that, if the other data to which the extracted link information is linked include concealed information, inquires of a user whether concealment of the concealed information is necessary,
wherein, if the result of the inquiry indicates that the concealment is necessary, the changing unit changes the link information linked to the other data including the concealed information to information that does not linked to the other data including the concealed information.

5. The document editing apparatus according to claim 1, further comprising:
a search unit that searches the target document for concealed information,
wherein the changing unit replaces the concealed information searched for by the search unit with other information.

6. A non-transitory computer readable medium storing a program causing a computer to execute a process comprising:
extracting link information linked to other data from a target document; and
changing the link information to information that is not linked to the other data if the other data to which the extracted link information is linked includes concealed information.

7. A document editing method comprising:
extracting link information linked to other data from a target document; and
changing the link information to information that is not linked to the other data if the other data to which the extracted link information is linked includes concealed information.
